(19) United States
(12) Patent Application Publication
(10) Pub. No.: US 2009/0317628 A1
(43) Pub. Date: Dec. 24, 2009

(54) METHODS AND APPARTUS TO PREVENT CONTAMINATION OF A PHOTORESIST LAYER ON A SUBSTRATE

(75) Inventors: Mehul Naik, San Jose, CA (US); Keisuke Mizuuchi, Sunnyvale, CA (US); Huixiong Dai, San Jose, CA (US); Michael Armacost, San Jose, CA (US); Li-Qun Xia, Cupertino, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 12/176,392

(22) Filed: Jul. 20, 2008

Related U.S. Application Data
(60) Provisional application No. 60/951,181, filed on Jul. 20, 2007.

(51) Int. Cl. B32B 9/00

(52) U.S. Cl. 428/333; 428/702

(57) ABSTRACT

In one aspect, a method is provided which includes (1) providing a substrate including a photoresist layer and an additional layer which may be a potential source of contaminants, and (2) preventing a release of contaminants from the additional layer, wherein preventing the release of contaminants from the additional layer protects the photoresist layer from exposure to contaminants from the additional layer. Numerous other aspects are provided.

The present application claims priority from U.S. Provisional Patent Application Ser. No. 60/951,181, filed Jul. 20, 2007 and titled “Methods and Apparatus to Prevent Contamination of a Photoresist Layer on a Substrate” (Docket No. 7791/L), which is hereby incorporated by reference herein in its entirety.

### FIELD OF THE INVENTION

The present invention relates generally to electronic device fabrication, and more particularly to methods and apparatus to prevent contamination of a photoresist layer on a substrate, such as a photoresist layer.

### BACKGROUND OF THE INVENTION

During certain electronic device fabrication processes, portions of a substrate may be coated with a photoresist layer to generate a pattern (e.g., a two-dimensional pattern) on a substrate. Portions of a photoresist layer exposed to radiation, such as ultraviolet light, change in chemical properties in comparison with non-exposed portions. This enables a pattern of exposed versus non-exposed portions to be generated in a photoresist layer. It has been found that various factors may affect the physical and/or chemical properties of photoresist. Accordingly, a need exists to improve control over such factors to provide for suitable patterning of a photoresist layer.

### SUMMARY OF THE INVENTION

In a first aspect of the invention, a method is provided which includes (1) providing a substrate including a photoresist layer and an additional layer which may be a potential source of contaminants, and (2) preventing a release of contaminants from the additional layer, wherein prevention of the release of contaminants from the additional layer protects the photoresist layer from exposure to contaminants from the additional layer.

In another aspect of the invention, an apparatus is provided which includes a substrate having (1) a photoresist layer, (2) an additional layer which may be a source of contaminants and (3) a cap layer formed over the additional layer, wherein the cap layer prevents a release of contaminants from the additional layer, protecting the photoresist layer from exposure to contaminants from the additional layer.

Other aspects of the present invention will become more fully apparent from the following detailed description, the appended claims and the accompanying drawings.

### BRIEF DESCRIPTION OF THE DRAWING(S)

FIG. 1 is a cross sectional view of an exemplary substrate including a photoresist layer.

FIG. 2 is a cross sectional view of an exemplary substrate as provided in accordance with an embodiment of the present invention.

FIG. 3 is a cross sectional view of an exemplary substrate provided in accordance with an additional embodiment of the present invention.

### DETAILED DESCRIPTION

It has been found that photoresist layers used to pattern substrates are often sensitive to the presence of contaminants. In particular, the chemical properties of photoresist may be adversely affected by exposure to such contaminants. It has been found that additional layers of a substrate (i.e., aside from the photoresist layer) may act as a source of contaminants to the photoresist layer, depending on their composition. In accordance with the invention, a photoresist layer is protected from such sources of contamination to prevent exposure of the photoresist layer to the contaminants, thus avoiding adverse influences that the contaminants may have on the photoresist layer.

According to embodiments of the invention, a substrate may be processed such that a layer of the substrate that is a potential source of contamination is covered with a protective layer (a ‘cap layer’) which prevents contaminants from leaking, migrating, outgassing or otherwise being released from the potentially contaminating layer. In this manner, the photoresist layer is protected from potential sources of contamination. The cap layer may be formed by a process that adds material (e.g., deposition) to the substrate. Additionally or alternatively, the cap layer may be formed by processing the substrate such that material is removed from one or more layers of the substrate (e.g., the potentially contaminating layer).

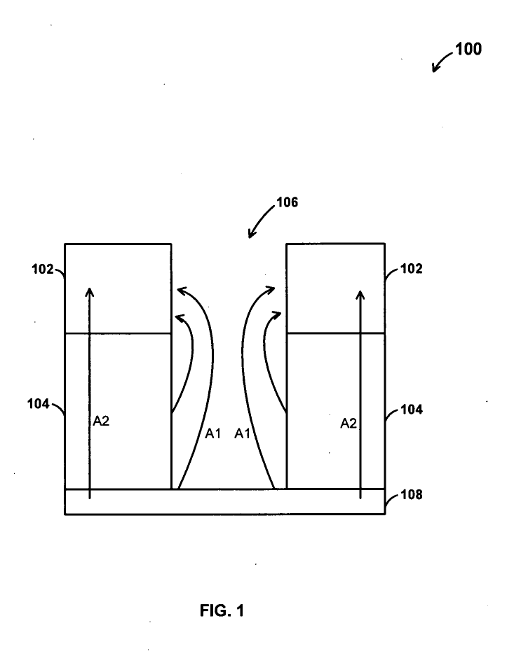

FIG. 1 is a cross sectional view of an exemplary substrate 100. The substrate 100 includes a photoresist layer 102 formed on a dielectric layer 104 (e.g., an oxide layer such as SiO₂, a low K dielectric such as a carbon doped oxide, or another dielectric). The dielectric layer 104 is, in turn, formed on a base layer 108. As shown, a feature, such as a through-hole or via 106 extends vertically through a portion of the photoresist layer 102 and the dielectric layer 104, terminating at the base layer 108. Although three layers 102, 104, 108 are depicted in FIG. 1, this is merely for purposes of illustration and the inventive concepts disclosed herein apply equally to substrates that include a larger or smaller number of layers.

The photoresist layer 102 may comprise a photosensitive material which changes in physical and/or chemical properties in response to exposure to radiation, such as visible or ultraviolet light. The photoresist material may comprise organic molecules, resins and/or polymers (e.g., polyhydroxy-styrene-based polymers). The photoresist layer 102 may be formed on the substrate 100 using a number of techniques including spin coating. When spin coating is employed, the thickness of the photoresist layer 102 may be controlled by a spin rate of the substrate 100, for example. Other suitable techniques may be employed to deposit the photoresist layer 102 on the substrate 100 to achieve a desired thickness. Exemplary photoresist layer thicknesses range from about 800 to 5000 angstroms, although other thicknesses may be used.

As noted, the photoresist layer 102 may be employed during patterning processes in which a precisely defined pattern (e.g., a two-dimensional pattern) may be formed in the photoresist layer 102. In some embodiments, a pattern may be generated by transmitting light through a mask having an inscribed pattern onto an unexposed photoresist layer. The pattern inscribed in the mask, or a reverse image of the pattern inscribed in the mask, is thereby transferred to the photoresist layer 102. After exposure, the photoresist layer 102 may be developed in a suitable developing solution to complete image transfer to the photoresist. The patterning of the photoresist layer 102 enables features such as via 106 to be formed at precisely determined locations on the substrate 100 in subsequent procedures such as etching, for example.

The dielectric layer 104 may comprise a silicon oxide (SiO) layer, such as silicon dioxide, a low K dielectric or any other layer having suitable electrical and/or physical properties. For example, in some embodiments, the dielectric layer 104 may comprise a carbon-doped silicon oxide layer. In one particular embodiment, the dielectric layer 104 may include a low K dielectric having a thickness of about 200 angstroms to 1 micron, although other thicknesses may be used.

As noted above, the via 106, which, in the embodiment depicted comprises a through-hole extending through the photoresist and dielectric layers 102, 104 may be generated subsequent to patterning of the photoresist layer 102. As shown in FIG. 1, the via 106 may have vertical sidewalls. In some embodiments, the sidewalls of the via 106 may be tapered or otherwise shaped.

In one or more embodiments, the base layer 108 may comprise a SiCN layer, although any suitable material may be employed. The base layer 108 may be employed to isolate one or more layers and/or materials (not shown) situated below the base layer 108, as an etch stop, or for any other suitable purpose.

The base layer 108 may act as a source of contaminants to the photoresist layer 102 directly through ‘outgassing’ of particles from the base layer 108 to the photoresist layer 102 (shown by curved arrows A1 in FIG. 1) and/or indirectly, by migration of particles from the base layer 108 through the dielectric layer 104 to the photoresist layer 102 (shown by straight arrows A2 in FIG. 1). It is noted however, that other layers of the substrate 100 may act as a source of contaminants which may adversely affect the photoresist layer 102, alternatively or in addition to the base layer 108.

The contamination may affect various physical and/or chemical properties of the photoresist material in layer 102, including, for example, solubility and pH level. For example, portions of the photoresist layer 102 may become basic (i.e., pH greater than 7) due to exposure to contaminants.

As stated, contamination may have an adverse affect on the properties of the photoresist layer 102. For example, due to changes in the pH and/or solubility in the photoresist layer 102, residues of photoresist material may remain after operations intended to completely remove the photoresist layer 102 (e.g., developing and/or cleaning procedures). The remnant residues may adversely impact the electrical properties (e.g., resistance) of portions of the substrate 100 and devices formed therein.

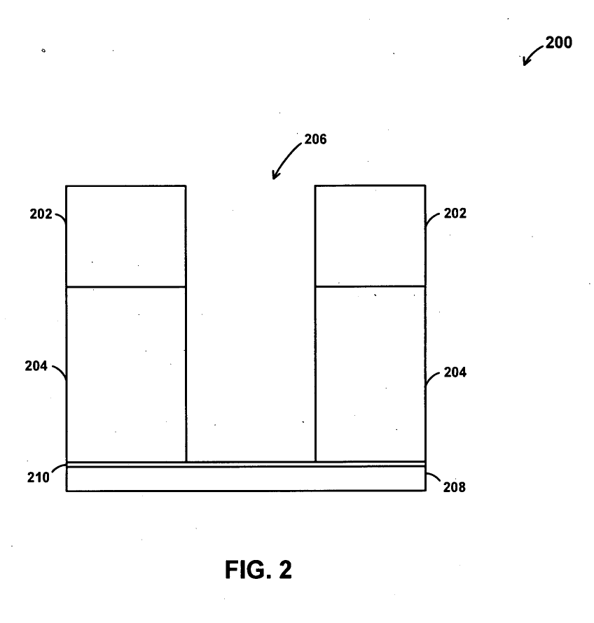

Referring to FIG. 2, a cross sectional view of a substrate 200 provided in accordance with an embodiment of the present invention is shown. As depicted in FIG. 2, the substrate 200 may include layers and features similar to those of the exemplary substrate 100 discussed above with reference to FIG. 1, including a photoresist layer 202, a dielectric layer 204, a via 206 and a base layer 208. The same layer thicknesses described with reference to FIG. 1, or any suitable layer thicknesses, may be used.

As depicted in FIG. 2, an additional cap layer 210 is formed between the base layer 208 and the dielectric layer 204. In this embodiment, the base layer 208 is assumed to be a potential source of contamination for the photoresist layer 202. The cap layer 210 may comprise a thin film formed over the base layer 208 using various techniques including plasma treatment and/or deposition (e.g., physical vapor deposition (PVD), chemical vapor deposition (CVD) and plasma-enhanced chemical vapor deposition (PECVD)). Thus, the cap layer 210 may be formed using depository or non-depository processes. In some embodiments, the cap layer 210 may have a thickness sufficient to prevent diffusion of material covered by the cap layer 210 into the dielectric layer 204 (e.g., particularly when the dielectric layer 204 is a porous low K material such as a carbon doped oxide). Exemplary cap layer thicknesses range from about 50 to 500 angstroms for PECVD deposited oxide, although other thicknesses may be used.

In one or more embodiments, the material of the cap layer 210 may comprise a thin oxide layer, such as silicon oxide or silicon dioxide, and/or another nitrogen-free dielectric layer. Additionally or alternatively, the cap layer 210 may be formed by treating the surface of the base layer 208 to stabilize the surface (e.g., to stabilize and/or remove the species, such as nitrogen, that may contaminate the photoresist layer 202). In the case of a SiCN base layer, such a plasma treatment may form a nitrogen-free or nitrogen-reduced SiC layer which effectively caps the underlying SiCN material. For example, exposure of a SiCN layer to a helium or similar plasma may remove carbon and nitrogen atoms from a top surface region of the layer.

In one embodiment, the cap layer 210 may be formed by removal of material from the base layer 208. For example, a cap layer 210 comprising SiC may be formed from a SiCN base layer 208 by removal of nitrogen (N) from the SiCN during plasma treatment or another suitable process. A combination of surface treatment of the base layer 208 and deposition of capping material may be used to form the cap layer 210.

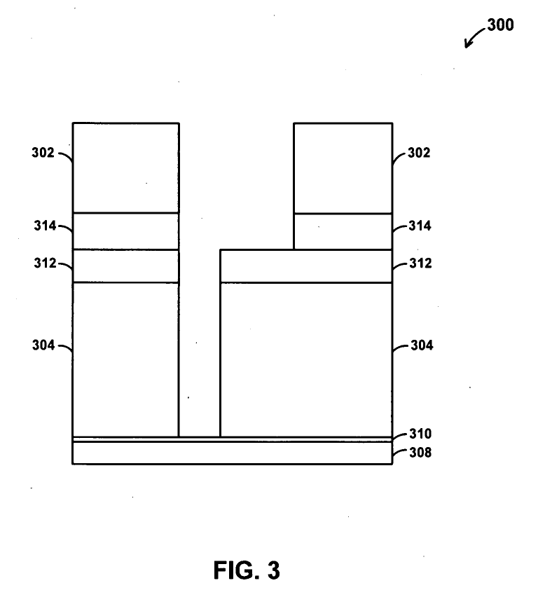

FIG. 3 is a cross sectional view of another exemplary substrate 300 provided according to an embodiment of the present invention which includes a number of intermediate layers. The substrate 300 may include a photoresist layer 302, a low k dielectric layer 304 and a base layer 308 similar to the layers described in FIGS. 1 and 2. A cap layer 310, which may be similar to the cap layer 210 described above with respect to FIG. 2, may be formed directly over the base layer 308 between the base layer 308 and the low k dielectric layer 304. In addition, the substrate 300 may include a silicon oxide layer 312 or other layer formed on top of the low k dielectric layer 304, and an anti-reflective layer 314 or other layer formed over the silicon oxide layer 312 directly under the photoresist layer 302. The depicted layers 302, 304, 308, 310, 312, 314 are exemplary and a larger or smaller number of layers may be provided.

In one embodiment, the base layer 310 may comprise SiCN having a thickness of about 50 nanometers, although other materials and thicknesses may be used.

As noted above, the base layer (e.g., 108, 208, 308) may not be the only potential source of contamination within a substrate. Thus, according to the present invention, additional cap layers may be formed over other potentially contaminating layers (e.g., silicon oxide layer 312) to prevent outgassing or migration of chemical species from such layers that may adversely affect the properties of the photoresist layer (e.g., 102, 202, 302).

The foregoing description discloses only exemplary embodiments of the invention. Modifications of the above disclosed apparatus and methods which fall within the scope of the invention will be readily apparent to those of ordinary skill in the art. For instance, in some embodiments, combinations of processes may be employed. For example, a wash may be employed in combination with a plasma treatment to prevent contamination of the photoresist layer.

Accordingly, while the present invention has been disclosed in connection with exemplary embodiments thereof, it should be understood that other embodiments may fall within the spirit and scope of the invention, as defined by the following claims.

The invention claimed is:

1. A method comprising:
providing a substrate including a photoresist layer and an additional layer, the additional layer being a potential source of contaminants; and
preventing a release of contaminants from the additional layer;
wherein preventing the release of contaminants from the additional layer protects the photoresist layer from exposure to contaminants from the additional layer.

2. The method of claim 1, wherein preventing the release of contaminants from the additional layer comprises forming a cap layer over the additional layer.

3. The method of claim 2 wherein forming the cap layer comprises forming a dielectric layer over the additional layer.

4. The method of claim 3 wherein forming the dielectric layer comprises forming an oxide layer.

5. The method of claim 2 wherein forming the cap layer comprises treating the additional layer so as to remove contaminants from the additional layer.

6. The method of claim 2 wherein the additional layer comprises a SiCN layer.

7. The method of claim 6 wherein the cap layer comprises an oxide layer.

8. The method of claim 6 wherein the cap layer has a thickness of about 50 to 500 angstroms.

9. The method of claim 6 wherein the cap layer comprises a portion of the SiCN layer that is treated to remove nitrogen from the portion of the SiCN layer.

10. An apparatus comprising:
a substrate, including:
a photoresist layer;
an additional layer, the additional layer being a potential source of contaminants; and
a cap layer formed over the additional layer;
wherein the cap layer prevents a release of contaminants from the additional layer, protecting the photoresist layer from exposure to contaminants from the additional layer.

11. The apparatus of claim 10 wherein the cap layer is an oxide layer.

12. The apparatus of claim 11 wherein the cap layer has a thickness of about 50 to 500 angstroms.

13. The apparatus of claim 10 wherein the cap layer comprises a portion of the additional layer treated so as to remove contaminants from the additional layer.

14. The apparatus of claim 10 wherein the additional layer comprises a SiCN layer.

15. The apparatus of claim 14 wherein the cap layer comprises a portion of the SiCN layer that is treated to remove nitrogen from the portion of the SiCN layer.
